(19) United States
(12) Patent Application Publication
(10) Pub. No.: US 2008/0290648 A1
(43) Pub. Date: Nov. 27, 2008

(54) Label with Improved Antiforgery Security

(76) Inventors: Arne Koops, Nev-Lankau (DE); Sven Reiter, Hamburg (DE)

Correspondence Address: NORRIS, MCLAUGHLIN & MARCUS, PA, 875 THIRD AVENUE, 18TH FLOOR, NEW YORK, NY, 10022, US

(21) Appl. No.: 12/094,812

(22) PCT Filed: Dec. 4, 2006
(86) PCT No.: PCT/EP06/69273

§ 371 Date: Jul. 8, 2008

(30) Foreign Application Priority Data
Dec. 19, 2005 (DE) 10-2005-061-24.9

(51) Int. Cl. B42D 15/00

(52) U.S. Cl. 283/81

(57) ABSTRACT

The invention relates to a label with antiforgery security, comprising an adhesive layer applied to a lower face of a support layer. In or on the bare face of the adhesive layer, a plurality of inclusions are present which contain at least one reversibly detective additive. When the label is bonded to a base, the inclusions are forced into the adhesive layer such that layers of the label above the inclusions are deformed, thereby forming haptically distinguishable and optically visible bumps in a surface of an upper support layer.

The invention relates to a label with improved antiforgery security, comprising a carrier layer, especially varnish layer, very particularly of thermoset varnish for laser inscription, with an adhesive layer on the lower side of the carrier layer.

For the identity marking of parts on vehicles, machinery, and electrical and electronic devices, use is being made increasingly of technical labels as, for instance, model identification plates, process control labels, guarantee badges, and testing plaquettes.

Inherent in many of these applications is the need for a more or less pronounced degree of antiforgery security. This antiforgery security applies primarily to the period of attachment and to the total service life on the part to be marked. Removal or manipulation ought to be impossible without destruction or visible, irreversible alteration.

In order to increase further the security of the labels against forgery the labels themselves are increasingly being required to make a contribution to security by means of a particular design.

In especially sensitive areas of application there must also be a security stage for the production of the labels. If it were too easy to acquire and mark such labels and to produce copies, third parties would be able to carry out unauthorized circulation of articles.

This additional antiforgery security must, however, not hinder subsequent identification of the applied label for originality by means of a rapid, unambiguous, simple, and nondestructive method.

Identity marking by means of laser labels is acquiring increasing priority particularly in the automotive industry, especially for high-value marking. It is used to place data and advisory information, such as tire pressure or fuel type, on a wide variety of components of the automobile for the benefit of its subsequent user. In the upstream manufacturing stages as well, important production data may be conveyed by way of a laser label.

For this application, the label may be inscribed with a barcode. A suitable reader device enables an assembly team to read off information on model, color, and special equipment from the barcode directly on the production line.

Not only this standard information, however, but also sensitive security data such as chassis number and vehicle identification number are positioned on the vehicle by means of labels. In the case of theft or accident, this information is of great importance for tracing both vehicle and manufacturing stages.

Owing to the costs of acquiring a laser inscription unit, which are high in comparison to those for conventional label printing systems, for many criminal organizations the direct copying of the plate set is not an option. Forgeries produced by conventional printing processes are easy to recognize visually. For this reason, attempts are often made to detach the plate set from vehicles and reapply it to other vehicles.

If detached, a label can easily be used to give a stolen vehicle a different identity (new chassis number). As a result, tracing the vehicle is virtually impossible.

In order to counter attempts at manipulation, therefore, the label material used must be extremely forgeryproof. As far as possible, it must not be nondestructively detachable from the bond substrate.

In particular it must not be possible to bond a label which has been detached to another substrate again without this manipulation being visible.

Additional security can be achieved by a combination of a very fragile material with high bond strengths. The bond strength of the material to the substrate plays an important part. It is critical for resisting any attempt at manipulation by detachment.

As well as the standard material there are modified labels, which are intended to make it impossible to copy the material by virtue of additional security features such as embossments, holograms, or a permanent UV impression (footprint).

High-performance controllable lasers for burning marks such as text, codes, and the like are widespread. The requirements imposed on the material that is to be inscribed include the following:
It should be capable of rapid inscription.
A high degree of spatial resolution capability should be achieved.
It should be extremely simple to use.
The decomposition products should not be corrosive.

For special cases, moreover, additional features are called for:
The laser-produced indicia should have sufficiently high contrast to be legible without error at a far distance even under unfavorable conditions.
Heat resistance should be high; for example, up to more than 200° C.
Resistance to weathering, water, and solvents is desired.

Known materials used for this purpose, such as printed paper, Eloxed aluminum, painted metal or PVC sheets, do not meet all of these requirements.

DE U 81 30 861 discloses a multilayer label comprising a thin and a thick, self-supporting, opaquely pigmented varnish layer. Both layers are composed of a solventlessly applied and electron beam cured varnish, the layer thicknesses being different. The label is inscribed by using a laser to burn away the upper, thinner varnish layer, so that the lower, thicker varnish layer becomes visible, said lower layer preferably being of a contrasting color to the first layer.

This inscription is a kind of gravure, ruling out possibilities for manipulation as exist with traditional imprints using inks. As a result of the base materials used and the production process, the label is made so brittle that its removal from the substrates without destruction is virtually impossible.

Laser labels of this kind are employed in particular for rational and variable inscription for the purpose of producing plate sets. These plate sets contain the total number of labels needed, for example, on components that require labeling in a motor vehicle (VIN plate, plates relating to tire pressure, trunk loading, key data for engines and ancillary equipment, etc.).

As far as antiforgery security is concerned, a laser sheet such as is known from DE U 81 30 861 and is available, for example, as tesa 6930® from tesa, is a product with a very brittle structure which gives it a good basis for documenting, and hence frustrating, any attempts at manipulation.

Nondestructive removal of the laser-inscribed label in one piece from its original bonding substrate requires a great deal of effort and particular conditions.

This effort is so great that said label easily passes all current detachability tests by the major testing institutions, such as, for example, “Prüfung von Fabrikschildern aus Platten, Blechen und Folien sowie deren Befestigung durch Kleben” [Testing of plant plates made from plaques, metal sheets, and foils, and their fastening by adhesive bonding] by the German motor transport office, and “Marking and Labeling System Materials MH 18055” by Underwriters Laboratories Inc.

This certified antiforgery security, which must always be seen in relation to the effort needed for manipulation, is having to face up to heightened requirements concerning proof of originality. This means that by means of a bonded laser label it should be documented that the marked component is an original. Since, as already mentioned earlier, both the laser sheet and laser inscription units are freely available on the market, there exists here a possibility for organized criminality on a large scale. Using the aforementioned hardware and the freely available laser sheets, stolen vehicles can be furnished with new labels which are difficult if not impossible to distinguish from the actual original labels.

EP 0 645 747 A specifies a laser-inscribable, multilayer label material composed of a first layer and a second layer which is optically different from the first layer, said first layer being removable by means of laser radiation in accordance with a desired text image or print image, in the course of which the surface of the second layer is rendered visible. Disposed between the layers, furthermore, is a transparent polymer sheet which forms a carrier layer.

DE 44 21 865 A1 specifies a monolayer laser label comprising a carrier layer made of plastic, said layer comprising an additive which changes color under laser irradiation.

The carrier layer is coated on one side with a self-adhesive composition which where appropriate is covered with a release paper or release film.

DE 199 09 723 A1 discloses a security sheet which has a carrier layer contained within which there is an identification medium. By means of a contactless inscription process it is possible to deliberately bring about selective and local changes in the diffusion properties of this identification medium. Where the security sheet thus inscribed is adhered to a workpiece, the identification medium diffuses toward the substrate surface where it brings about a detectable reaction. This diffusion and/or reaction occurs only in those regions of the substrate surface where diffusability has been initiated, or unhindered, by the inscription procedure. Consequently, the security sheet allows unambiguous inscribing and identification of the workpiece.

The security sheet is inscribed by means of a contactless process. Accordingly, a rapid and flexibly variable inscription which is insensitive to soiling can be achieved even in the plant environment. The inscribing of the security sheet, and hence the change in the diffusion properties of the identification medium, may be done in particular by means of electromagnetic radiation. To inscribe the security sheet it is particularly advantageous to use a laser which allows both temperature-sensitive and light-sensitive inscription (as used here, “light” embraces the entire range of the electromagnetic spectrum that is available to the laser). Lasers have the further advantage of enabling high-contrast inscriptions with a free choice of pattern, of allowing rapid changes to the pattern inscribed, and of process reliability in use in the plant environment.

All of the labels set out above, following application to an article, provide a high level of antiforgery security, since the labels can be inscribed only with technically refined lasers which are therefore expensive and not universally accessible, with the consequence that the equipment needed to copy or alter said labels has generally been more expensive—at least in the past—than the product in question. Moreover, the brittleness of the material often results in destruction of the label in the case of attempts at manipulation or removal.

With the progress of technology, however, lasers of this kind have become more and more favorable, so making it worthwhile in an increasing number of cases to acquire such lasers, particularly in the case of relatively large products such as, for example, motor vehicles which are provided with such a label for the purpose of identity marking in the engine compartment as well as elsewhere.

In this situation, the production of unauthorized copies is made much easier by the ready and freely accessible supply of laser label stock and the existence, now widespread, of laser inscription units.

Using flat, sharp blades, moreover, it is possible to separate labels completely from the substrate. Particularly on plastics substrates such as polyethylene or polypropylene, the bond between adhesive and substrate shows weaknesses.

Despite increased bond strength on metallic or painted substrates, it is possible there as well to detach some of the labels without destroying them, by using special tools. A special bladed tool can be guided at a shallow angle beneath the label. By means of careful cutting movements it is possible to lift one edge, so producing what is termed a finger tab. In this way a point of attack is produced which makes detachment easier.

In addition, there is a continual requirement not only to prevent forgeries and the dissemination of copies but also to individualize the label, for use particularly in an automobile, for a specific customer and to supply it exclusively to that customer.

This individualization has to meet two important criteria, namely
the label must be readily and rapidly identifiable, and
the label must be uncopyable.

By means of these two criteria it is possible to ensure that only the proper authority, in this case the automaker, is able to define and identity-mark components as originals.

First attempts at individualizing the carrier material of the label are disclosed in DE 199 04 823 A1. It describes a process for producing a sheet, in which first of all a support foil is embossed by means of an embossing tool, the embossing tool having holographic structures. A sheet is then produced on the embossed support foil, so that at least one hologram is reproduced on the sheet.

DE 197 46 998 A1 discloses a laser label with at least one layer of plastic that is coated on one side with a self-adhesive composition, the plastic having incorporated within it an additive suitable for reversible magnetic or electrical characterization or an additive suitable for reversible optical characterization, said additive being made perceptible, more particularly visible, by means of electron beams, X-rays, more particularly by visible light, especially by IR or UV radiation.

It is an object of the invention to provide a label which meets the abovementioned requirement of enhanced antiforgery security, and in particular to enhance the security of the laser-inscribable sheets against forgery in such a way that, even using a cutting tool, it is virtually impossible to carry out nondestructive detachment of a bonded label, and in particular it cannot be bonded again without this manipulation being demonstrable or detectable, said label further possessing, in particular, a high contrast, high resolution capability, high temperature stability, and ease of use.

This object is achieved by means of a label as described in the main claim. The subclaims provide particularly advantageous embodiments of the subject matter of the invention, and also provide for its use.

The invention accordingly provides a label with improved antiforgery security, comprising at least one carrier layer with an adhesive layer on its lower side. In or on the exposed side of the adhesive layer there are a plurality of discrete inclusions which comprise at least one reversibly detectable additive.

In a first preferred embodiment of the invention, the reversibly detectable additive in the discrete inclusions of the adhesive layer is an additive suitable for magnetic and/or electrical detection and/or optical detection, the additive being made perceptible, more particularly visible, by means of electron beams, X-rays, more particularly by visible light, especially by IR or UV radiation.

The discrete inclusions are applied, more particularly by printing or coating, preferably to the exposed side of the adhesive layer.

The inclusions are preferably applied in regular patterns. It is possible to transfer lines, fields, images, logos, text, etc., in different sizes and kinds.

With further preference the inclusions are disposed on the label stock material from which the labels are diecut in such a way that the individual diecut labels have punched-through inclusions in the edge region which are therefore accessible or visible from outside.

Particularly regular lines and linear patterns give rise to characteristic patterns of “luminous dots” at the edges of the label and, moreover, are particularly economic in terms of material and financial resources. After the diecutting or laser cutting of the label and its application to the substrates, a pattern which is characteristic in terms of colors and geometries is evident at the edge of the label if a suitable detection unit is selected, typically an illumination source.

With further preference the bonding of the label to a substrate is accompanied by the pressing of the discrete inclusions into the adhesive in such a way that the layers of the label located above the inclusions undergo deformation, and so haptically perceptible and optically visible impressions are produced in the surface of the upper carrier layer of the label.

The discrete inclusions are formed substantially by a polymer matrix, preferably varnishes, with particular preference cationic UV varnishes.

In one particularly advantageous embodiment the cationically curable UV varnish is SICPA 360076 from SICPA, Aarberg.

Likewise suitable as print varnishes are SICPA 36-2 series cationic or UV flexographic print varnishes based on cycloaliphatic epoxy resins, the latter accounting for more than 30% by weight in the formulation of the varnishes.

The height of the inclusions is more particularly 1 to 20 μm, with particular preference 0.5 to 20 μm. The inclusions are preferably printed onto a liner which lines the adhesive, or directly onto the layer of adhesive.

Suitability as additives in the inclusions is possessed by color-imparting particles, which may comprise fine color pigments or visible particles with a size of the order of 0.1 to 5 mm. Absent auxiliaries, the use of daylight fluorescent inks allows the “fingerprint” to be seen. It is therefore preferred to use color pigments or particles which do not absorb in the range of visible light and hence are normally invisible. Only when the label is illuminated with a lamp of appropriate wavelength are the color pigments excited and luminesce characteristically.

Additionally, it is possible to employ long-afterglow (phosphorescent) pigments or fluorescent pigments which are excited solely or predominantly by UV radiation and which emit in the visible region of the spectrum (as an overview, see, for example, Ullmann's Enzyklopädie der technischen Chemie, 4th edition, 1979, Verlag Chemie). Also known, however, are IR-active luminescent pigments. Examples of systems featuring UV fluorescence are xanthenes, coumarins, naphthalimides, etc., sometimes referred to in the literature under the rubric of “organic luminescent substances” or “optical brighteners”. The addition of a few percent of the luminescent substances in question is sufficient, with binding into a solid polymer matrix, in particular, being favorable in respect of luminosity and stability. Use may be made, for example, of formulations comprising RADGLO® pigments from Radiant Color N.V., the Netherlands, or Lumilux® CD pigments from Riedel-de Haen. Inorganic luminescent substances are also suitable. Metal sulfides and metal oxides, generally in conjunction with appropriate activators, have proven favorable as long-afterglow substances, particularly with emission of light in the yellow region. These substances are available, for example, under the tradename Lumilux® N or, as luminescent pigments improved in respect of stability, luminosity, and duration of afterglow, under the tradename LumiNova® from Nemoto, Japan.

Besides color pigments excited by means of IR radiation, or UV-active systems, suitability in principle is also possessed by luminescent substances which are excited by electron beams, X-rays, and the like.

These dyes and color pigments, listed by way of example, are incorporated into the formulation of the preferred varnish layer in amounts of 0.1% to 50% by weight, preferably at 1% to 25% by weight, with very particular preference at 7% by weight.

When selecting the color pigments it should be ensured that they are sufficiently stable for the label production process and do not undergo irreversible alteration under the process conditions (possibly thermal drying, electron beam or UV curing). For long-term applications of the labels it is advantageous that these luminescent substances, which are generally sensitive, are embedded in a polymer matrix of the inclusions and protected.

Further advantageous embodiments use substances which can be detected magnetically or electrically, and also thermochromic pigments which undergo a reversible color change when there is a change in temperature.

In one advantageous embodiment of the invention the label is composed of
a) a carrier layer made of plastic and
b) comprising an additive which under laser irradiation exhibits a marked change in color, said layer
c) being coated on one side with an adhesive which
d) where appropriate is lined with a release paper or release film.

The carrier layer has a thickness of preferably from 10 to 200 μm, in particular from 50 to 100 μm.

Suitable carrier layers are composed of plastics such as polyesters, poly(meth)acrylates, polycarbonate, and polyolefins, and of radiation curable systems such as unsaturated polyesters, epoxy acrylates, polyester acrylates, and urethane acrylates, such as are also used for UV printing inks, especially those comprising a base polymer according to DE U 81 30 816, namely aliphatic urethane acrylate oligomers.

Suitable additives are, in particular, color pigments and metal salts, especially copper hydroxide phosphate or else Iriodin, a pearl luster pigment available commercially from Merck. These additives are admixed to the base polymer (as described, for example, in DE U 81 30 861) in particular in an order of magnitude ranging from several parts per thousand up to a maximum of 10% by weight, preferably in amounts from 0.1% to 10% by weight, in particular from 0.5% to 5% by weight, based on the total weight of the carrier layer. Following production of sheet material by means of known techniques such as extrusion, casting, coating, etc. with subsequent radiation-chemical crosslinking where appropriate, such films are coated with the adhesive layer.

When the standard lasers are used, especially the widespread solid state Nd-YAG lasers with a wavelength of 1.06 μm, a (marked) change in color takes place at the point where the laser strikes the surface of the material, giving sharply defined, high-contrast inscriptions and identity markings.

In a further advantageous embodiment the carrier layer is composed of a varnish, in particular of a cured varnish, preferably a radiation cured varnish, with particular preference an electron beam cured polyurethane acrylate varnish. In one alternative embodiment the carrier layer is composed of a polybutylene terephthalate.

With further preference, an outer, especially self-supporting, opaquely pigmented varnish layer is applied, preferably solventlessly, to the upper side of the varnish layer, i.e., the side opposite the side to which the adhesive layer has been applied, and is subsequently subjected, in particular, to electron beam curing.

The top varnish layer, formed from a cured, i.e., crosslinked, varnish, has a thickness of preferably from 1 to 20 μm, in particular 5 to 15 μm; the varnish layer has a thickness of preferably from 20 to 500 μm, in particular 30 to 100 μm.

In principle, four types of varnish can be used, provided their stability is adequate; for example, acid curing alkyld-melamine resins, addition crosslinking polyurethanes, free radically curing styrene varnishes, and the like. Particularly advantageous, however, are radiation curing varnishes, since they cure very rapidly without lengthy evaporation of solvents or exposure to heat. Varnishes of this kind have been described, for example, by A. Vrancken (Farbe und Lack 83, 3 (1977) 171).

In one preferred embodiment the two varnish layers exhibit maximum color contrast to one another.

This is because the label of the invention is composed preferably of an opaque top layer, which can be easily burnt through by a laser beam, and a bottom layer, in particular in a contrasting color to the first, the bottom layer being such that it is not easily burnt through by the laser beam.

In another advantageous embodiment, either the varnish layer or the second varnish layer is printed with an ink comprising a fluorescent or phosphorescent additive in such a way that in the finished label the ink layer is between the two varnish layers.

In the case of two-layer and multilayer labels, a suitable additive may be incorporated into the varnish layer that is decisive for the text. The outer varnish layer itself, for the high gloss model identification plates, for example, therefore remains unchanged; only at the laser engraving stage is the varnish layer partially exposed at the sites of the inscription. Where the varnish layer—white, for example—includes color pigments, color particles, colored fibers, and the like, these become visible at the engraved sites.

Suitable additives are also the additives already mentioned comprehensively above.

These dyes and color pigments, listed by way of example, are incorporated into the formulation of the respective varnish layer in amounts of 0.1% to 50% by weight, preferably at 1% to 25% by weight, with very particular preference at 7% by weight.

After punching/laser cutting of the desired label geometries, and final inscription by means of a laser beam with text, barcodes, logos, etc., the label is present in its final form. If, for example, long-afterglow pigments have been incorporated into the varnish layer, upon corresponding excitation of the luminescent pigments the label displays a characteristic afterglow in the region of the laser inscription and at the edges, permitting its easy and rapid identification as an original label. Apart from the specific light source and, where appropriate, eye protection to counter disruptive ambient light, no other expensive equipment is needed—following testing, the label remains unchanged.

Also possible for incorporation into the stated varnish layers are substances which can be detected magnetically or electrically, and also thermochromic pigments which undergo a reversible color change in response to a change in temperature.

Furthermore it is appropriate, as an additional hidden security step, to add substances to the carrier layer that lead to said layer having electrical conductivity. By means of suitable measuring equipment, which is transportable, easy to use, and inexpensive to purchase, and suitable electrodes, the conductivity of the varnish layer can be determined directly on the bonded label. The electrodes are attached at two different points, A and B, of the carrier layer, and a voltage is applied. If there is a coherent electrical conductivity between A and B, it is possible to measure a current flow which may have a characteristic value in dependence on the nature and amount of the additive used. Since, even when the label is used directly on metals, the varnish layer is separated from the conductive metal by the electrically insulating adhesive layer, there is no risk of erroneous measurements.

Falsification by subsequent manipulation is prevented in particular by the fact that the conductivity measurement may be made not only from edge to edge of the labels but also between any desired points exposed by laser treatment.

To allow conductivity to be detected here, the complete carrier layer must be coherently and three-dimensionally conductive. A laser-inscribable label of this kind can be produced by adding electrically conductive substances to the formulation of the preferred varnish layer; this may be done in addition to the existing pigments or else at least partly in replacement of the pigments present, in order to retain the good processing properties of the varnish pastes. Suitable conductive additives include in principle electrically conductive metallic, organic, polymeric, and inorganic substances, preference being given to the use of metals. Especially for white or pale varnish layers, the inherent color of the conductive additive is a factor in selection. Conductive carbon black is likewise suitable, albeit only for black or dark varnish layers.

In order to ensure good conductivity, there should be a minimum limit concentration of additive ensured, so that sufficient particles are present in the varnish layer to touch and have contact with one another. Below this limit concentration, a conductive path from A to B is no longer ensured in the three-dimensional microstructure of the base layer. It is therefore preferred to use metallic particles, preference being given to fibers having a high ratio of length to cross section, since in this case it is possible to ensure three-dimensional conductivity with lower concentrations than with spherical particles; additionally, the alteration in color of the varnish layer by the fibers is reduced. From cost/benefit analysis, the metals used are preferably copper, iron, aluminum, and steel, and the alloys of these metals, although expensive, highly conductive metals such as silver and gold are suitable as well. The fiber dimensions are from 0.1 to 50 mm length with cross sections of from 1 to 100 μm, preference being given to using metal fibers having a diameter of from 2 to 20 μm with a cross section-to-length ratio of approximately 1:100 to 1:1000. Such fibers are incorporated homogeneously into the known formulation at from 0.5 to 25% by weight, preferably from 2 to 10% by weight, and the formulation is applied and cured in accordance with DE U 81 30 861.

Following adhesive coating and lining with release paper, the label material can be inscribed by laser beam. As a result of the removal of the top varnish layer, the indicia of the varnish layer are exposed in the region of laser inscription—when a voltage is applied by way of suitable electrode contacts to two different points A and B in these indicia, a conductivity is measured which is characteristic of the varnish layer and is determined by, inter alia, the nature and amount of the conductive additive. Hence it is possible to produce customer-specific label stock material by means of defined formulations.

Preference is further given to an embodiment of the label which is composed of at least one varnish layer obtainable by applying the varnish layer—preferably solventlessly—to a printed or embossed support carrier sheet, and then curing it. The printing or embossing of the support carrier sheet produces a negative impression on the visible surface of the first varnish layer of the label of the invention.

The support carrier sheet is printed in particular by the flexographic process, since the UV flexographic printing process possesses a very high degree of freedom in terms of the design of geometries and is able to provide good print quality at a very low price particularly for web materials ranging from paper to film. With this technology it is possible to transfer lines, fields, images, logos, text, etc. from printing plate to printing substrate, in different sizes and kinds.

In order subsequently to achieve a visible and sensorially perceptible impression on the laser label, the printing should have a height from 0.1 μm to 15 μm. It is preferred to choose a height from 1 to 5 μm. In addition, the esthetics and character of the print can be varied by means of the course of the printed dots.

For the realization of the invention it is also possible to use the other conventional printing techniques, which are known as relief printing processes. They include letterpress and screen printing.

It is particularly preferred if in the first varnish layer the impression of the printed support carrier sheet is present as a depression of from 0.1 to 15 μm, preferably from 1 to 5 μm.

The embossing of the support carrier sheet can be carried out, for example, in varying thickness and/or depth using a metal embossing die (obtainable from Gerhardt). The depth of embossing is dependent on the set embossing pressure, which acts on the magnetic cylinder used in the embossing process, and on the nature of the backing cylinder. Wrapping of the backing cylinder (with Tesaprint® or with a polyester film, for example) results in strong embossing.

Furthermore the embossing tool used may comprise holographic structures, so that the structure is reproduced on the varnish layer and produces at least one hologram.

Therefore, the side of the embossing tool facing the materials to be embossed is shaped so as to give a structure which comprises a diffraction grating or a holographic image.

Since the hologram is produced in the varnish layer itself, there is no harmful multilayer structure, and the diffraction grating produced in this way possesses the same durability and laserability as the varnish layer itself.

In one advantageous embodiment the support carrier sheet is composed of a permanently embossed thermoset or thermoplastic material, in particular of polyester or polyamide.

In a further advantageous embodiment, the carrier layer comprises an identification medium.

The diffusion properties of this identification medium can be deliberately selectively and locally varied with the aid of lasers. Where the carrier sheet inscribed in this way is adhered to a workpiece, the identification medium diffuses toward the substrate surface, where it brings about a detectable reaction. This diffusion or reaction takes place only in those inclusions of the substrate surface in which the diffusion capability has been initiated, or not hindered, by the inscription operation. Accordingly, the carrier layer allows unambiguous inscription and identification of the workpiece.

The identification medium selected is a substance which initiates a detectable reaction on the substrate. For this purpose, the identification medium must be matched to the material properties of the substrate. For instance, the identification medium may comprise a dye—which is matched to the substrate—which diffuses locally into the substrate surface and colors it. Alternatively, the identification medium may comprise a substance which undergoes a chemical reaction with the substrate surface. Of particular interest in this context are reactions in which the substrate surface is locally removed or locally expanded, so that following removal of the sheet the inscription of the substrate can be detected optically or else by touch. For the marking of metallic substrates, an identification medium which comprises an etching substance is particularly recommended.

In order to increase the level of theft protection, it may be advisable to choose an identification medium whose influence on the underlying substrate cannot be detected using the naked eye. This can be achieved with an identification medium which influences the absorption and reflection properties of the substrate, for example, only in the UV or IR region but not in the visible region.

The substrate contains no visible traces of the marking. The regions affected in this case continue to include the marking, which can easily be detected by informed security personnel with the aid, for example, of a UV or IR viewing device. In particular, the identification medium may be chosen such that the detectability, e.g., the UV fluorescence, is manifested only at certain wavelengths of the testing light.

For industrial use of the carrier layer, especially in the automotive industry, the sheet must be very robust with respect to the effects of temperature and light. These requirements can best be met if the security sheet has physical barriers which prevent the diffusion of the identification medium in the uninscribed state of the carrier layer.

During the inscription operation, these barriers are locally destroyed or weakened, so that in the areas thus weakened a selective diffusion of the identification medium can take place. In order to make the inscription highly resistant to temperature and/or light, the temperatures or light intensities which are required to destroy the barriers must be significantly higher than those to which the object to be marked is subject in the service state, even under extreme ambient conditions.

This prevention of the diffusion of the identification medium, which can be eliminated by contactless inscription, can advantageously be realized by microencapsulation of the identification medium in the carrier layer. The identification medium is enclosed in capsules whose walls may be composed, for example, of wax and/or fat and can be broken open by, for example, the local effect of heat in the relevant regions of the sheet, so that the identification medium contained therein is able to escape and, on coming into contact with the substrate, is able to diffuse into and/or react with said substrate.

The inscription can be given a particularly high temperature stability if the barrier is formed by a barrier layer which is arranged in sheet form between carrier layer and an adhesive layer and which, in the uninscribed state of the sheet, prevents the diffusion of the identification medium out of the carrier layer. Inscription of the carrier layer locally punctures the barrier layer, so that the identification medium is able to escape locally at these puncture points from the carrier layer and to diffuse into the adhesive layer.

Those regions of the barrier layer which remain undamaged in the course of inscription effectively prevent the diffusion of the identification medium and hence a reaction in these uninscribed regions.

It is possible on the one hand for the carrier layer to constitute a kind of matrix, in which the identification medium is embedded. Alternatively, the material of the carrier layer may itself constitute the identification medium, so that the carrier layer is composed of identification medium.

The label's carrier layer(s) are preferably inscribed by means of a contactless inscription method. Therefore, even in the plant environment, it is possible to obtain inscription which is insensitive to dirt, is rapid, and can be flexibly varied. The inscription of the carrier layer can be carried out in particular by means of electromagnetic radiation.

For inscribing the carrier layer it is particularly advantageous to use a laser, which can be used to carry out both temperature-sensitive and light-sensitive inscription (in this context, the term “light” includes the entire region of the electromagnetic spectrum that is accessible to the laser). Lasers have the additional advantage of allowing high-contrast inscriptions with any desired choice of pattern, of allowing rapid changes to the inscription pattern, and of being reliable in use in the plant environment.

The adhesive layer may be composed of a pressure-sensitive adhesive and/or hotmelt adhesive and of a heat-activatable reactive adhesive.

In one embodiment of the label the adhesive layer comprises a mixture of the pressure-sensitive adhesive and/or hotmelt adhesive with the heat-activatable reactive adhesive.

With further advantage the adhesive layer comprises the pressure-sensitive adhesive and/or hotmelt adhesive and the heat-activatable reactive adhesive arranged alternately in stripes.

In addition to the arrangement of the adhesives in stripes, however, all other partial geometric arrangements and forms are possible, more particularly dot formations, with varying distances between the adhesives, etc.

The selection of the arrangement is guided by the particular end use and location of use of the label.

The heat-activatable reactive adhesive preferably comprises
i) a thermoplastic polymer, with a fraction of from 30 to 90% by weight, especially 50% by weight,
ii) one or more tackifying resins, with a fraction of from 10 to 70% by weight, especially 50% by weight, the resins being, in particular, epoxy resins with hardeners, possibly accelerators as well, and/or phenolic resins,
iii) if desired, silverized glass beads,
iv) if desired, metalized particles,
v) if desired, nondeformable or difficult-to-deform spacer particles which do not melt at the reactivation temperature.

The preferred thermoplastic polyurethanes (TPUs) are known as reaction products of polyester- or polyetherpolyols and organic diisocyanates such as diphenylmethane diisocyanate. They are composed of predominantly linear macromolecules. Such products are available commercially mostly in the form of elastic granules; for example, from Bayer AG under the trade name “Desmocoll”.

By combining TPU with selected compatible resins it is possible to lower the softening temperature to a sufficient extent. Occurring in parallel with this, even, is an increase in the adhesion. Examples of resins which have proven suitable include particular rosins, hydrocarbon resins, and coumarone resins.

Alternatively, the reduction in softening temperature can be achieved by combining TPU with selected epoxy resins based on bisphenol A and/or F and a latent hardener.

By means of the chemical crosslinking reaction (on the basis of epoxides or phenolic resin condensation) of the resins at elevated temperature, high strengths are achieved between the reactive adhesive and the surface that is to be bonded.

The addition of the reactive resin/hardener systems also leads to a lowering of the softening temperature of the abovementioned polymers, which advantageously reduces their processing temperature and processing speed. The reactive adhesive is a product which is self-adhesive at room temperature or slightly elevated temperatures. When the product is heated, there is also a short-term reduction in viscosity, as a result of which the product is able to wet even rough surfaces.

The compositions of the reactive adhesive can be varied widely by changing the type and proportion of the base materials. It is also possible to obtain further product properties such as, for example, color or thermal or electrical conductivity by means of specific additions of dies, organic and/or mineral fillers, such as silica, and/or powders of carbon and/or of metal.

The beads and/or soft conductive particles that may be present in the reactive adhesive and/or in the pressure sensitive and/or hotmelt adhesive permit conductivity in the z direction, and possibly in the x-y plane as well.

The pressure-sensitive adhesive and/or hotmelt adhesive is, for example, a pressure-sensitive adhesive of the kind disclosed in DE 15 69 898 C. The overall disclosure content of that specification is therefore part of this invention.

An acrylate adhesive is applied, for example, at 25 to 35 g/m².

The adhesive layer designed in accordance with the invention does not impair the label. The physical and chemical resistance properties are not altered.

From the application standpoint, there is no detriment to the label in terms of inscribabilty with a laser or legibility of the information.

With further preference, for the case of an inflexible carrier layer between carrier layer and adhesive layer, a reversibly flexible compensation layer is present which is solid at temperatures of up to 50° C. and softens or melts at higher temperatures, and is capable of compensating stresses that occur.

The compensation layer is preferably composed of thermoplastics such as polyvinyl acetate or polyamide, for example.

Additionally suitable are all plastics composed of linear or thermolabilely crosslinked polymer molecules, such as polyolefins, vinylpolymers, polyesters, polyacetals, polycarbonates or else polyurethanes and ionomers, for example.

As thermoplastics for the compensation layer it is additionally possible to use thermoplastically processable plastics having pronounced entropy-elastic properties, referred to as thermoplastic elastomers.

The properties of the compensation layer can be varied widely by means of additions of plasticizers, fillers, stabilizers, and other additives, and also by fiber reinforcement.

The compensation layer may be coated from solution or inserted as a film between carrier layer and adhesive.

The thickness of the compensation layer is preferably from 0.2 to 20 μm. In another preferred embodiment the weight per unit area is 0.5 to 5 g/m².

The compensation layer is capable of compensating the stresses that occur, particularly at high temperatures, within the label, by softening and/or melting beyond a certain temperature range. On the basis of this plastic behavior, the stresses are broken down within the compensation layer. The label, accordingly, is flexible at high temperatures.

If the label or the substrate cools down again thereafter, the compensation layer enters the solid state, so that the bond strength of the label is in no way adversely affected.

The melting and subsequent solidification of the compensation layer can be repeated almost ad infinitum.

A further advantage of the invention is that the service possibilities can be defined via the properties of the compensation layer: for example, via the temperature at which the melting process begins.

The label of the invention features a multiplicity of advantages which were not foreseeable in this way for the skilled worker.
Following application, the labels are quickly perceived, optically visible, and tactile.
Identification is possible without auxiliary means; in other words, an authenticity check can be made without UV or IR lamps, etc.
Since identification is unambiguous, the risk of a misassessment is low.
The label is virtually impossible to detach from the substrate.
The label cannot be bonded again without this manipulation being detectable.

Following corresponding excitation of the (luminescent) pigments there is a characteristic afterglow produced in the region of the label edges, which permits its ready and rapid identification as an original label.

After the second bonding, i.e., the manipulation, the change in the inclusions comprising the additives produces a different picture, and so the manipulation is immediately detectable.

Apart from the specific light source and, where appropriate, eye protection to counter disruptive ambient light, no further costly and inconvenient equipment is needed.

In the majority of cases, furthermore, the haptic impression of the discrete inclusions in the label surface will disappear, thereby actualizing a second security feature in the label. The discrete inclusions are generally severed in such a way that their greatest portion remains in the adhesive located on the substrate.

A particularly advantageous embodiment of the invention is illustrated with the aid of the figures described below, without wishing to subject the invention to any unnecessary restriction.

FIG. 1 shows the label with two carrier layers, the lower side of one carrier layer bearing an adhesive layer printed with a plurality of discrete inclusions;

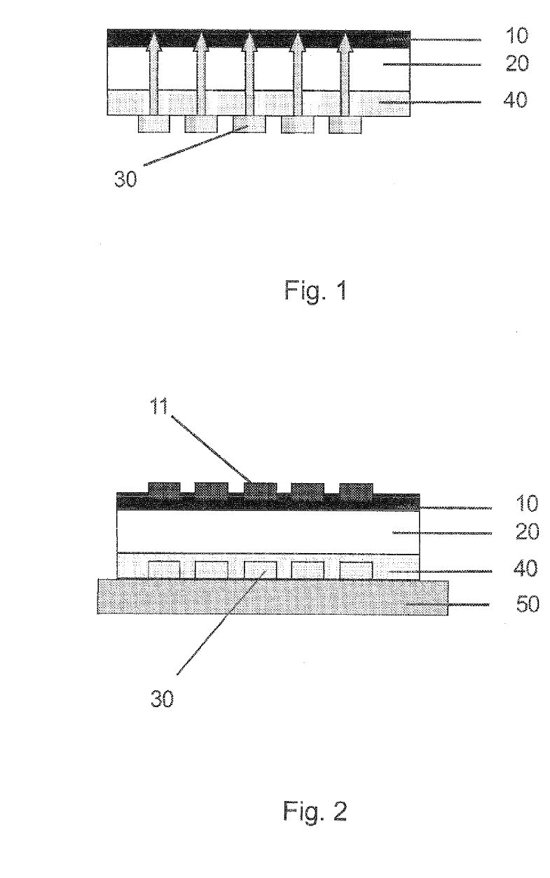

FIG. 2 shows the label of FIG. 1 after it has been bonded to a substrate, together with the impression of the inclusions in the surface;

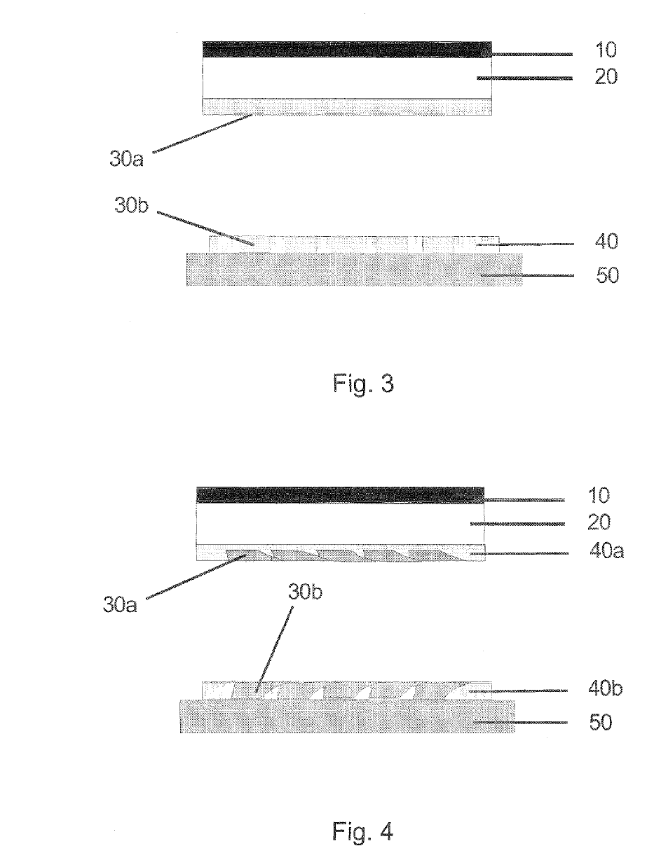

FIG. 3 shows the label of FIG. 1 after it has been peeled from the substrate by means of a sharp knife;

FIG. 4 shows the label of FIG. 1 after it has been peeled from the substrate by means of a sharp knife, the inclusions being influenced at the same time.

FIG. 1 shows the structure of a label of the invention.

In the label there is a second varnish layer 10 on the thicker varnish layer 20, which is on a layer of an adhesive 40.

Printed onto the adhesive coating 40 are a plurality of discrete inclusions 30 which are composed of a polymer, more particularly a varnish, comprising detectable additives.

In the printing of the label, care has been taken to ensure that in the edge region of the label there are punched-through inclusions 30, which are therefore accessible or visible from the outside.

FIG. 2 differs from FIG. 1 only in as much as the label has been bonded to a substrate 50. The discrete inclusions 30 are pressed into the adhesive 40 in such a way that the layers of the label located above the inclusions 30 undergo deformation, and so haptically perceptible and optically visible impressions 11 are produced in the surface of the upper carrier layer of the label.

FIG. 3 shows the label of FIG. 1 after it has been peeled from the substrate by means of a sharp knife. The knife unavoidably severs the adhesive coating 40, and at the same time the inclusions 30 are separated as well, and so parts of the inclusions 30 remain (30a) in the adhesive 40a remaining on the label, while the other parts, 30b, are located on the substrate together with the other part of the adhesive, 40b.

Detection of the additives in the inclusions 30a shows, if the label has again been bonded to a different substrate, that the amount of additives has become significantly less and in particular no longer coincides with the amount originally present in the label of FIG. 1. Furthermore, as a result of the “smearing”, the geometry of the discrete inclusions 30 has changed, which is also an indication that a third party has manipulated the label.

Finally

The expert can only conclude from this that there has been manipulation of the label of FIG. 3; in other words, the label has been detached and bonded again.

Finally the haptic impressions 11 of the discrete inclusions 30 in the label surface have disappeared.

In FIG. 4 the polymer matrix of the inclusions 30 has been formulated so that, when the inclusions 30 are severed, they are plastically deformed on the basis of the shearing stresses generated by the knife.

Although the inclusions 30 have been severed in such a way that almost the entire volume of each inclusion 30a has remained on the label, the renewed bonding of the label is nevertheless impossible without such renewed bonding being detectable. On the basis of the said stress, the inclusions 30a have undergone deformation such that the image of the additives that is seen by means of a detector no longer coincides with the image offered by the label of FIG. 1.

The purpose of the example below is to disclose a particularly advantageous label produced using a printed support carrier sheet, so that on the surface of the label there are embossments which result in a further high security factor.

### EXAMPLE

The support carrier sheet to be printed, in this case a 50 μm polyester film, was printed on a UV flexographic printing unit from SMB, and then UV-cured using a lamp from G&W. The printing height was between 1 and 5 μm.

The varnish used was a cationically curable UV varnish, SICPA 360076 from SICPA, Aarberg, which is tinted blue. The printing ink is optimized for processing by admixing 5% by weight of cylinder repellent.

The two polyurethane acrylate layers (laser layers) were coated wet on wet: that is, the upper, functional layer (black) and the lower, contrast layer (white) were coated on top of one another without the black layer being cured beforehand (advantage after curing: high interlaminate adhesion). The black layer was coated directly onto the printed carrier and the white layer was then coated onto the black layer.

The black layer was coated by way of a multiroll applicator mechanism (owing to the relatively low and relatively precise layer thickness of 5 to 15 μm), and the white layer was coated via a doctor blade (100 to 160 μm). The varnishes were a solvent-free “100%” system based on aliphatic polyurethane acrylates. The properties (viscosity) were adjusted by way of reactive diluent and copolymer. Curing was accomplished by means of electron beam curing at 80 KGy and 240 KeV.

The resulting material is referred to as laser stock material.

The adhesive (pressure-sensitive adhesive corresponding to DE 15 69 898 A1) was coated from solution via a doctor blade (35 g/m²) and crosslinked thermally thereafter. Coating was carried out on the release film (liner). Only at the end was the laser stock material laminated together with the adhesive.

The printed support carrier film was removed; in the upper varnish layer there was a deep, negative impression of the geometry.

1. A label with improved antiforgery security, the label comprising:
at least one carrier layer with an adhesive layer on its lower side,
a plurality of inclusions in or on an exposed side of the adhesive layer, wherein the plurality of inclusions comprise at least one reversibly detectable additive,
wherein the label bonds to a substrate by pressing at least one of the plurality of inclusions into the adhesive layer such that the at least one carrier layer of the label located above the plurality of inclusions undergoes deformation and produces one or more haptically perceptible and optically visible impressions in a surface of an upper carrier layer of the label.

2. The label according to claim 1, wherein the at least one carrier layer is composed of a first varnish layer.

3. The label according to claim 2, wherein a second varnish layer is applied atop the first varnish layer, wherein the second varnish layer is subsequently cured.

4. The label according to claim 3, wherein the first varnish layer has a thickness of 20 to 500 μm, and/or the second varnish layer has a thickness of 1 to 20 μm.

5. The label according to claim 3, wherein the two varnish layers exhibit maximum color contrast to one another.

6. The label according to claim 1, wherein the reversibly detectable additive in the plurality of inclusions of the adhesive layer is an additive suitable for magnetic detection, electrical detection and/or optical detection.

7. The label according to claim 1, wherein the plurality of inclusions are applied to the exposed side of the adhesive layer by printing or coating.

8. The label according to claim 1, wherein the plurality of inclusions are substantially formed by a varnish.

9. The label according to claim 1, wherein a flexible compensation layer is located between the at least one carrier layer and the adhesive layer.

10. An automotive construction that includes the label according to claim 1.

11. The label according to claim 2, wherein the first varnish layer is a cured varnish.

12. The label according to claim 2, wherein the first varnish layer is a radiation cured varnish.

13. The label according to claim 2, wherein the first varnish layer is an electron beam cured polyurethane acrylate varnish.

14. The label according to claim 3, wherein the first varnish layer has a thickness of 30 to 100 μm and/or the second varnish layer has a thickness of 5 to 15 μm.

15. The label according to claim 1, wherein the plurality of inclusions are substantially formed by a cationic UV varnish.

16. The label according to claim 1, wherein the reversibly detectable additive in the plurality of inclusions of the adhesive layer is made perceptible by means of electron beams, X-rays, IR radiation or UV radiation.
